(19) United States
(12) Patent Application Publication
(10) Pub. No.: US 2026/0304019 A1
(43) Pub. Date: Oct. 1, 2026

(54) WIND NOISE REDUCTION EARPHONE STRUCTURE AND EARPHONE

(71) Applicant: Shenzhen Dancing Future Technology Ltd., Shenzhen (CN)

(72) Inventors: Chuanbo WANG, Shenzhen (CN); Hongguo DENG, Shenzhen (CN); Qifeng CHEN, Shenzhen (CN); Zhenlong XIE, Shenzhen (CN); Siqi TANG, Shenzhen (CN)

(21) Appl. No.: 19/478,251

(22) PCT Filed: Oct. 9, 2024
(86) PCT No.: PCT/CN2024/123781

§ 371 Date: Oct. 23, 2025

(30) Foreign Application Priority Data
Oct. 10, 2023 (CN) 202311310178.1
Oct. 10, 2023 (CN) 202322714714.6
Oct. 10, 2023 (CN) 202322720054.2

(51) Int. Cl. H04R 1/10; H04R 1/08

(52) U.S. Cl. CPC H04R 1/1066; H04R 1/086; H04R 1/105; H04R 1/1083; H04R 2410/05; H04R 2410/07; H04R 2460/01

(57) ABSTRACT

A wind noise reduction earphone structure and an earphone are provided, the wind noise reduction earphone structure includes an ear hook portion and a main body portion, the ear hook portion is connected to the main body portion, the ear hook portion is configured to be worn on an ear, so that the main body portion is located on a front side of the ear, at least one first microphone is installed inside the main body portion, the main body portion includes an arc-shaped wall protruding from an inner side to an outer side of the main body portion, the arc-shaped wall is provided with at least one first sound pickup hole, and the first sound pickup hole is configured to be acoustically coupled with the first microphone.

The present application claims priority to Chinese Patent Application No. 202322714714.6, filed with the China National Intellectual Property Administration on Oct. 10, 2023, and entitled “WIND NOISE REDUCTION EARPHONE STRUCTURE AND EARPHONE”, Chinese Patent Application No. 202311310178.1, filed with the China National Intellectual Property Administration on Oct. 10, 2023, and entitled “WIND NOISE REDUCTION EARPHONE STRUCTURE AND EARPHONE”, and Chinese Patent Application No. 202322720054.2, filed with the China National Intellectual Property Administration on Oct. 10, 2023, and entitled “WIND NOISE REDUCTION EARPHONE STRUCTURE AND EARPHONE”, which are incorporated herein by reference in their entirety.

### TECHNICAL FIELD

The present application relates to the technical field of earphones, and more particularly, to a wind noise reduction earphone structure and an earphone.

### BACKGROUND

Earphones have been widely used in people's daily life, and may be used in conjunction with electronic devices such as mobile phones and computers. With increasing demands of users, earphones have more and more functions, for example, earphones with a call function and earphones with an active noise reduction function are provided. The earphones with the call function and the earphones with the active noise reduction function both require a microphone to pick up external sound signals and convert them into electrical signals for processing by a signal processor in an earphone system, so as to provide the earphones with corresponding functions.

However, due to a sound pickup characteristic of the microphone, that is, when a diaphragm of the microphone vibrates, an electrical signal is generated. When there is strong wind in the environment, it will cause excessive vibration amplitude of the microphone diaphragm, resulting in noise, that is, relatively large wind noise is generated, which affects user experience.

### SUMMARY

An object of the present application is to provide a wind noise reduction earphone structure and an earphone to solve the problem of relatively large wind noise in existing earphones.

In a first aspect, the present application discloses a wind noise reduction earphone structure, including a housing provided with at least one sound pickup hole, where at least one microphone is installed in the housing, a first acoustic channel is formed in the housing, the first acoustic channel includes a slow flow channel and a conduction channel that are in communication with each other, the sound pickup hole is in communication with the slow flow channel, the slow flow channel is configured to buffer gas flowing in from the sound pickup hole, and the conduction channel is acoustically coupled with the microphone.

In a second aspect, the present application discloses an earphone, including an electroacoustic transducer, where the earphone further includes the wind noise reduction earphone structure according to any one of the above.

In combination with the above technical solutions, the present application provides a wind noise reduction earphone structure and an earphone. By providing a first acoustic channel in a housing and connecting a sound pickup hole in the housing with a slow flow channel of the first acoustic channel, when wind blows in from the sound pickup hole, the slow flow channel can play a certain role in slowing down the wind, thereby slowing down a flow velocity of a wind fluid, reducing wind energy, further reducing wind noise, effectively improving a sound pickup effect of a microphone, and improving user experience.

### BRIEF DESCRIPTION OF DRAWINGS

FIG. 1 is a schematic structural view of an ear.

FIG. 2 is a schematic structural view of a wind noise reduction earphone structure worn on an ear according to an embodiment of the present application.

FIG. 3 is a first schematic structural view of a wind noise reduction earphone structure according to an embodiment of the present application.

FIG. 4 is a partial cross-sectional view of a wind noise reduction earphone structure according to an embodiment of the present application.

FIG. 5 is a schematic partial structural view of a main body portion according to an embodiment of the present application.

FIG. 6 is another schematic structural view of an arc-shaped wall according to an embodiment of the present application.

FIG. 7 is a schematic structural view of the wind noise reduction earphone structure in FIG. 2 when not worn.

FIG. 8 is a schematic diagram showing an arrangement of three first sound pickup holes.

FIG. 9 is a schematic diagram showing an arrangement of four first sound pickup holes.

FIG. 10 is a schematic diagram showing an arrangement of five first sound pickup holes.

FIG. 11 is a schematic structural view of another wind noise reduction earphone structure worn on an ear according to an embodiment of the present application.

FIG. 12 is a schematic structural view of a wind noise reduction earphone structure according to another embodiment of the present application.

FIG. 13 is a schematic structural view of yet another wind noise reduction earphone structure worn on an ear according to an embodiment of the present application.

FIG. 14 is a schematic structural view of an earphone worn on an ear according to another embodiment of the present application.

FIG. 15 is a partial cross-sectional view of an earphone according to an embodiment of the present application.

FIG. 16 is an enlarged view of a portion K in FIG. 15.

FIG. 17 is an enlarged view of a partial structure of a first acoustic channel according to an embodiment of the present application.

FIG. 18 is a schematic structural view of a mounting member, a bottom wall, a flow guiding wall and a conduction wall according to an embodiment of the present application.

FIG. 19 is a schematic orthographic projection view of a sound pickup hole and a second sound pickup hole on a second plane according to an embodiment of the present application.

FIG. 20 is a schematic structural view of an earphone in a first viewing angle according to an embodiment of the present application.

FIG. 21 is a schematic structural view of an earphone in a second viewing angle according to an embodiment of the present application.

FIG. 22 is a schematic partial structural view of a main body portion according to an embodiment of the present application.

FIG. 23 is a schematic structural view of an earphone worn on an ear according to another embodiment of the present application.

### DETAILED DESCRIPTION

The technical solutions in the embodiments of the present application will be described clearly and completely with reference to the drawings in the embodiments of the present application. Obviously, the described embodiments are only some embodiments of the present application, but not all embodiments. Based on the embodiments in the present application, all other embodiments obtained by those skilled in the art without creative efforts belong to the protection scope of the present application.

Embodiments of the present application provide a wind noise reduction earphone structure and an earphone. The following will first explain the definitions of a wearing state, a front side, a rear side, an upper side and a lower side of the ear, a human sagittal plane, a coronal plane, a horizontal plane, a sagittal axis, a coronal axis, a horizontal axis, and X, Y, Z directions involved in the text.

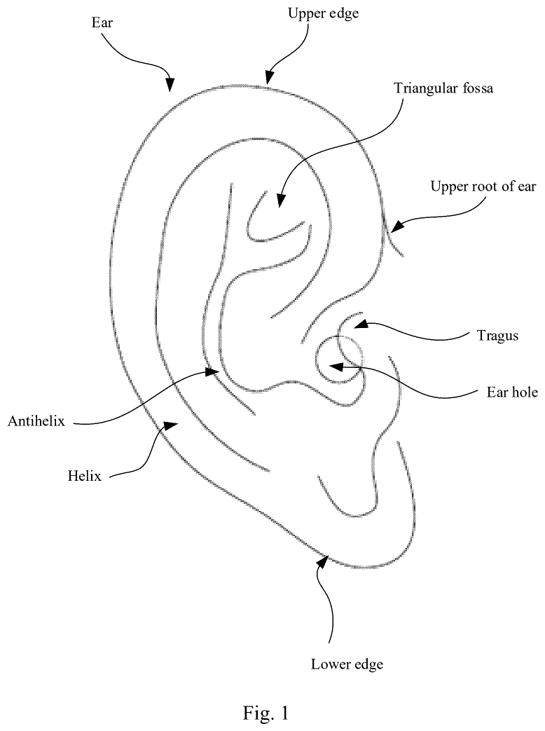

Please refer to FIG. 1, which is a schematic structural view of an ear. The front side and rear side of the ear are defined as follows. The “front side of the ear” described in the present application is a concept relative to the “rear side of the ear”, the former refers to a side of the ear away from the head, the latter refers to a side of the ear close to the head, the “upper edge of the ear” refers to an outer edge of an upper side of the helix of the ear, and the “lower edge of the ear” refers to an outer edge of a lower side of the helix of the ear, which are all for the user's ear.

The human sagittal plane, coronal plane, horizontal plane, sagittal axis, coronal axis and horizontal axis are defined as follows. As is well known, in the fields of medicine and anatomy, three basic sections of a sagittal plane, a coronal plane and a horizontal plane of the human body and three basic axes of a sagittal axis, a coronal axis and a vertical axis may be defined. The sagittal plane refers to a section perpendicular to the ground along a front-back direction of the body, which divides the human body into left and right parts; the coronal plane refers to a section perpendicular to the ground along a left-right direction of the body, which divides the human body into front and rear parts; the horizontal plane refers to a section parallel to the ground along an up-down direction of the body, which divides the human body into upper and lower parts. Correspondingly, the sagittal axis refers to an axis that passes through the coronal plane vertically along the front-back direction of the body, the coronal axis refers to an axis that passes through the sagittal plane vertically along the left-right direction of the body, and the vertical axis refers to an axis that passes through the horizontal plane vertically along the up-down direction of the body.

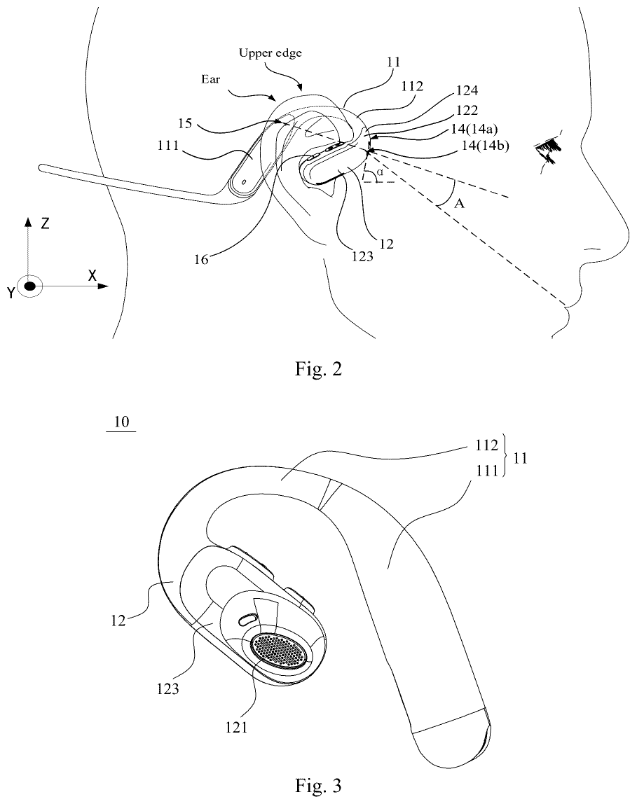

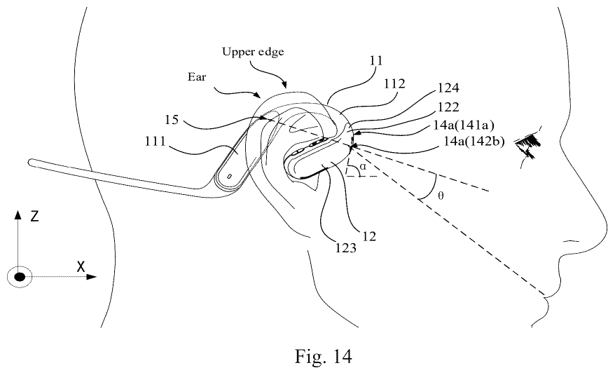

The X, Y, and Z directions are defined as follows. As shown in FIG. 2 and FIG. 14, for the convenience of description, the X, Y, and Z directions are defined respectively, the X direction is defined as being parallel to the sagittal axis and pointing to a front side of the human body, the Y direction is defined as being parallel to the coronal axis and pointing to a right side of the human body (out of the paper surface along FIG. 2 and FIG. 14), and the Z direction is defined as being parallel to the vertical axis and pointing to an upper side of the human body.

The above definitions of directions are only for the convenience of description, and the X, Y, and Z directions may be defined arbitrarily in accordance with the principles of the technical solution, including but are not limited to definition methods such as axial symmetry and angular symmetry of the above orientations.

It may also be understood that the X direction may be used to represent a positive direction of the sagittal axis, the Y direction may be used to represent a positive direction of the coronal axis, and the Z direction may be used to represent a positive direction of the vertical axis.

The wearing state is defined as follows. The “wearing state” described in the present application is a stable wearing state after the earphone is stably worn on the ear of the human body (as shown in FIG. 2 and FIG. 14), and the “natural state” is a state where the earphone is not subjected to any external force after being removed from the ear. Certainly, due to individual differences among users, the actual wearing state of the earphone may be somewhat different from the aforementioned wearing state.

It should be noted that, in the related art, an earphone with a call function and an earphone with an active noise reduction function both require a microphone to pick up external sound signals and convert them into electrical signals for processing by a signal processor in an earphone system, so as to provide the earphone with corresponding functions. However, due to a sound pickup characteristic of the microphone, that is, when a diaphragm of the microphone vibrates, an electrical signal is generated. When there is strong wind in the environment, it will cause excessive vibration amplitude of the microphone diaphragm, resulting in noise, that is, generating relatively large wind noise and affecting user experience.

Based on this, embodiments of the present application provide a wind noise reduction earphone structure and an earphone to solve the problem of relatively large wind noise in the earphone.

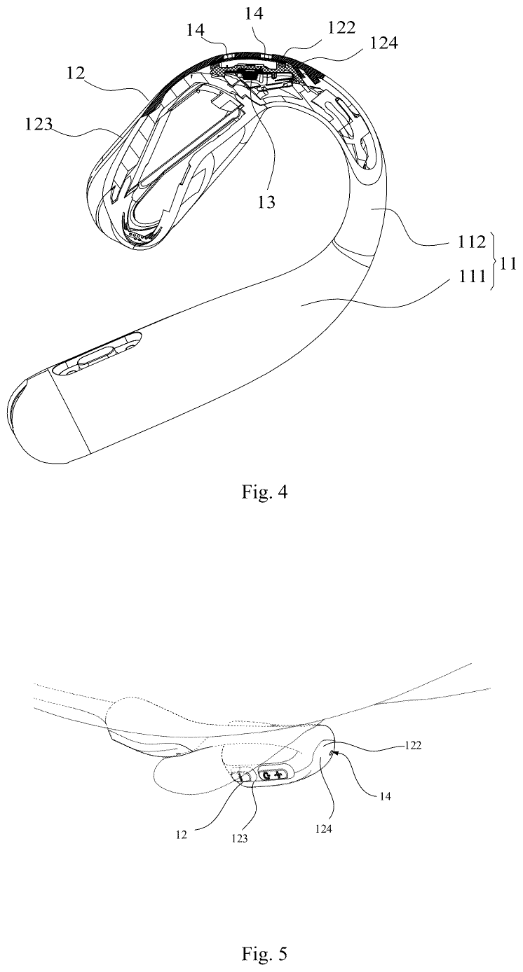

Please refer to FIGS. 1 to 4, where FIG. 2 is a schematic structural view of a wind noise reduction earphone structure worn on an ear according to an embodiment of the present application, FIG. 3 is a first schematic structural view of a wind noise reduction earphone structure according to an embodiment of the present application, and FIG. 4 is a partial cross-sectional view of a wind noise reduction earphone structure according to an embodiment of the present application. The wind noise reduction earphone structure 10 includes an ear hook portion 11 and a main body portion 12, the ear hook portion 11 is connected to the main body portion 12, and the ear hook portion 11 is configured to be worn on an ear, so that the main body portion 12 is located on a front side of the ear. It can be understood that the main body portion 12 is provided with a speaker (not shown) and a sound outlet hole 121, and the sound outlet hole 121 is acoustically coupled with the speaker, so that when the main body portion 12 is located on the front side of the ear, sound may be transmitted to an ear hole of the ear through the sound outlet hole 121, so that the user can hear corresponding sound information.

It can also be understood that, for the convenience of wearing, one end of the ear hook portion 11 is connected to the main body portion 12, and the other end of the ear hook portion 11 is bent and extending from the front side of the ear to a rear side of the ear via an upper edge of the ear, so that the earphone structure may be worn on the ear.

In order to pick up external sound signals and convert them into electrical signals for processing by the signal processor in the earphone system, at least one first microphone 13 is installed inside the main body portion 12. It may be understood that more than one first microphone 13 may form a first microphone array, so that external sound signals may be picked up more accurately.

As shown in FIG. 4 and FIG. 5, FIG. 5 is a schematic partial structural view of a main body portion according to an embodiment of the present application. The main body portion 12 may include an arc-shaped wall 122 protruding from an inner side to an outer side of the main body portion 12, the arc-shaped wall 122 is provided with at least one first sound pickup hole 14, and the first sound pickup hole 14 is configured to be acoustically coupled with the first microphone 13. It may be understood that the first sound pickup hole 14 may transmit external sound signals to the first microphone 13.

It may also be understood that, because the arc-shaped wall 122 is arranged in an arc shape, when wind acts on the arc-shaped wall 122, wind energy can quickly disperse to two sides of the arc surface, thereby reducing energy of the wind blowing into the first sound pickup hole 14, further reducing wind noise, effectively improving a sound pickup effect of the first microphone 13, and improving user experience.

It should be noted that, as a structure for transmitting sound, the first sound pickup hole 14 may have a cross-section in a circular, elliptical, triangular, quadrangular or irregular shape, and the specific shape thereof is not specifically limited in the present application.

In order to meet sound pickup quality of the first microphone 13, the area of the cross-section of the first sound pickup hole 14 is not less than 0.75 square millimeters. It may be understood that, in general, the larger the area of the cross-section of the first sound pickup hole 14, the better the sound pickup effect. However, when the area of the cross-section of the first sound pickup hole 14 is greater than a certain value, wind noise may be increased. Based on this, the area of the cross-section of the first sound pickup hole 14 in the present application is not greater than 3 square millimeters. That is, in order to meet the sound pickup quality of the first microphone and reduce wind noise, the area of the cross-section of the first sound pickup hole 14 is not less than 0.75 square millimeters and not greater than 3 square millimeters, for example, the area of the cross-section of the first sound pickup hole 14 is 0.75 square millimeters, 0.80 square millimeters, 1 square millimeter, 1.5 square millimeters, 2 square millimeters, 2.5 square millimeters or 3 square millimeters, so that the earphone has a better sound pickup effect.

As shown in FIGS. 2 to 5, the main body portion 12 includes a sound emitting section 123 and a transition section 124 for connecting the sound emitting section 123 and the ear hook portion 11, the transition section 124 includes the arc-shaped wall 122, one end of the arc-shaped wall 122 is connected to the sound emitting section 123, and the other end of the arc-shaped wall 122 is bent and extending toward the ear hook portion 11 and connected to the ear hook portion 11. In this way, the arc-shaped wall 122 may achieve a smooth and curved transition between the sound emitting section 123 and the ear hook portion 11, so as to disperse wind energy blowing toward the arc-shaped wall 122.

It should be noted that, generally, wind energy along the front side of the human body toward the rear side of the human body is higher than wind energy in other directions. Based on this, in order to better disperse relatively large wind energy, the arc-shaped wall 122 is arranged on a surface of the transition section 124 facing the front side of the human body. In this way, the energy of the wind blowing into the first sound pickup hole 14 can be better reduced, that is, wind noise can be better reduced, and the sound pickup effect of the first microphone 13 can be effectively improved.

Specifically, a middle protrusion of the arc-shaped wall 122 is gradually bent and extending to transit to left and right sides thereof to form a wind guiding surface, and the first sound pickup hole 14 may be located on the wind guiding surface. It may be understood that the wind guiding surface with such a shape is favorable for dispersing wind energy.

Preferably, the first sound pickup hole 14 may be located in the middle of the arc-shaped wall 122, that is, in the middle of the wind guiding surface. In this way, when wind acts on the arc-shaped wall 122, wind energy can quickly disperse to two sides of the wind guiding surface, thereby reducing the energy of the wind blowing into the first sound pickup hole 14, further reducing wind noise, and effectively improving the sound pickup effect of the first microphone 13.

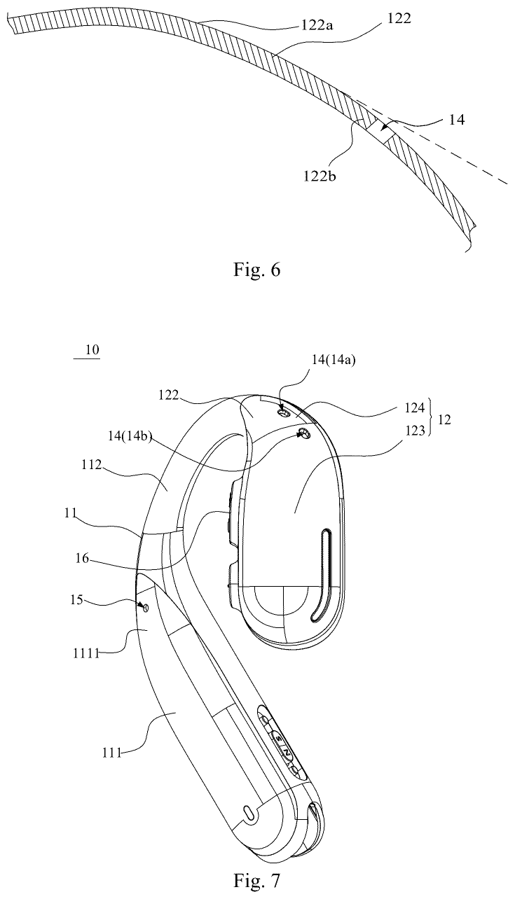

In some embodiments, different from the middle protrusion of the arc-shaped wall 122 described above, please refer to FIG. 6, which is another schematic structural view of an arc-shaped wall according to an embodiment of the present application. The arc-shaped wall 122 may also be arranged such that a protrusion at one end is gradually bent and extending to transit to the other end to form a wind guiding surface, that is, the arc-shaped wall 122 has a structure with a protrusion at one end, and the first sound pickup hole 14 may be arranged as far as possible from a position of the protrusion of the arc-shaped wall 122, that is, the first sound pickup hole 14 avoids a vertex of the arc-shaped wall 122. For example, a portion of the arc-shaped wall 122 away from the protrusion position has a gentle transition, and the first sound pickup hole 14 is arranged on the wind guiding surface with a gentle transition.

In some embodiments, the arc-shaped wall 122 includes a protruded first portion 122a and a gently transited second portion 122b, the second portion 122b is connected to the protruded first portion 122a, a tangent is made at the connection, the second portion 122b is gently bent inwards relative to the tangent, and the first sound pickup hole 14 is arranged in the second portion 122b.

In some embodiments, the arc-shaped wall 122 includes points with different radii of curvature, which may be between 2 millimeters and 40 millimeters. In some embodiments, the radii of curvature of the points may be between 2.65 millimeters and 37.5 millimeters, so that wind energy can be effectively dispersed. In some embodiments, the radius of curvature of each point may be 2 millimeters, 2.65 millimeters, 3.15 millimeters, 3.75 millimeters, 22.15 millimeters, 32.5 millimeters, 37.5 millimeters or 40 millimeters. It may be understood that the radius of curvature of each point may be any value between 2.65 millimeters and 37.5 millimeters, which is not limited in the present application.

In some embodiments, the radii of curvature of the points may be between 3.15 millimeters and 32.5 millimeters.

In some embodiments, the radii of curvature of the points may be between 3.75 millimeters and 22.15 millimeters. So that wind energy can be effectively dispersed.

It should be noted that, when using the earphone, the user most likely encounters oncoming wind, that is, the wind direction is along the front side of the human body toward the rear side of the human body.

Based on this, please refer to FIG. 2 and FIG. 7, FIG. 7 is a schematic structural view of the wind noise reduction earphone structure in FIG. 2 when not worn. In order to further improve the wind noise reduction effect, two first sound pickup holes 14 may be provided, which are a first sub-hole 14a and a second sub-hole 14b respectively. In the wearing state, the first sub-hole 14a is closer to the eye than the second sub-hole 14b in a positive direction of the sagittal axis (X direction). A first angle α between a connection line between the first sub-hole 14a and the second sub-hole 14b and the positive direction of the sagittal axis is less than or equal to 90 degrees. In this way, the connection line between the first sub-hole 14a and the second sub-hole 14b is designed at such an angle, which is favorable for unloading of wind energy, so as to further improve the wind noise reduction effect.

Preferably, the first angle α is less than or equal to 60 degrees. In some embodiments, the first angle a is less than or equal to 45 degrees. Further, in some embodiments, the first angle α is 0 degree.

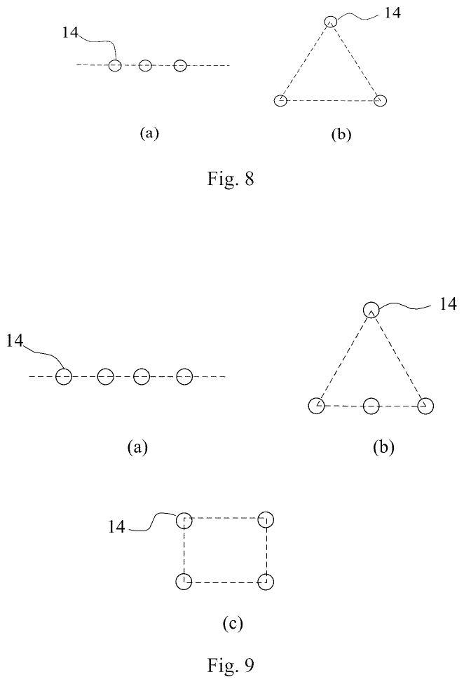

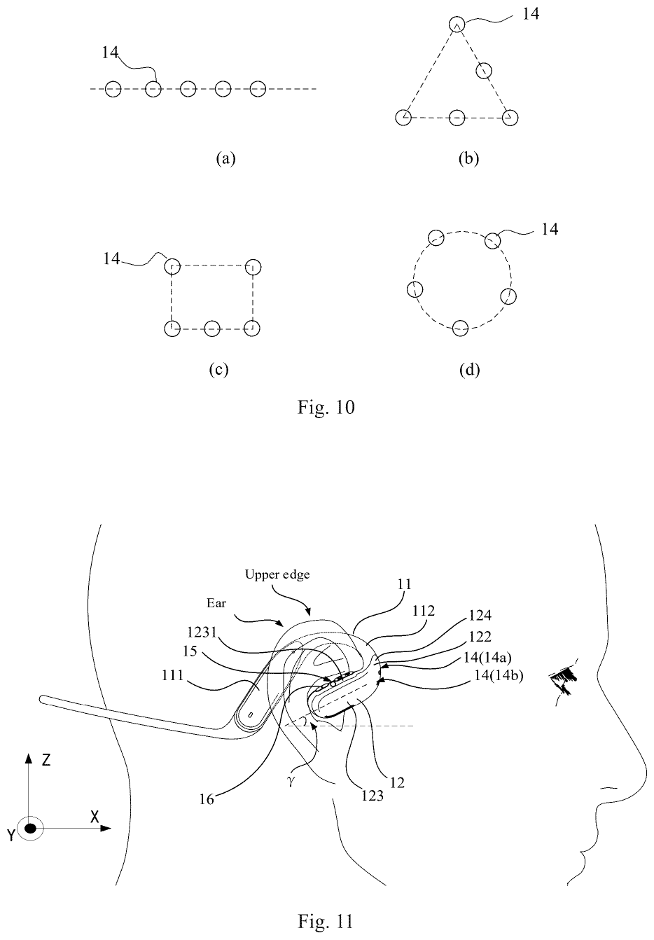

In some embodiments, at least three first sound pickup holes 14 may be provided, and the at least three first sound pickup holes 14 may be arranged in a line, a triangle, a quadrangle or a circle. For example, as shown in FIG. 8, which is a schematic diagram showing an arrangement of three first sound pickup holes, when three first sound pickup holes 14 are provided, the three first sound pickup holes 14 may be arranged in a line (FIG. a in FIG. 8) or a triangle (FIG. b in FIG. 8). As shown in FIG. 9, FIG. 9 is a schematic diagram showing an arrangement of four first sound pickup holes. When four first sound pickup holes 14 are provided, the first sound pickup holes 14 may be arranged in a line (FIG. a in FIG. 9), a triangle (FIG. b in FIG. 9) or a quadrangle (FIG. c in FIG. 9). As shown in FIG. 10, FIG. 10 is a schematic diagram showing an arrangement of five first sound pickup holes. When five or more first sound pickup holes 14 are provided, the first sound pickup holes 14 may be arranged in a line (FIG. a in FIG. 10), a triangle (FIG. b in FIG. 10), a quadrangle (FIG. c in FIG. 10) or a circle (FIG. d in FIG. 10).

In this way, due to the design of the plurality of first sound pickup holes 14, when contacting the arc-shaped wall 122, a large wind fluid may be dispersed into several small wind fluids, thereby the design playing a role in buffering the wind fluid, being favorable for unloading of wind energy, and further improving the wind noise reduction effect.

It should be noted that, in order to better reduce wind noise, in some embodiments, a second microphone and a second sound pickup hole acoustically coupled with the second microphone may also be provided, so that noise reduction may be performed in combination with a call noise reduction and an active noise reduction algorithm.

It may be understood that, the second microphone is provided and matched with the second sound pickup hole, and a microphone array may be formed together with the first microphone and the first sound pickup hole, so that call noise reduction may be realized.

It may also be understood that, by providing the second microphone and the second sound pickup hole, external noise signals may be collected and used as reference signals for noise reduction processing, and active noise reduction can be realized in combination with an algorithm of a noise reduction chip.

In some embodiments, at least one second microphone and at least one second sound pickup hole 15 may be arranged in the main body portion 12, for example, please refer to FIG. 11, which is a schematic structural view of another wind noise reduction earphone structure worn on an ear according to an embodiment of the present application. The second microphone and the second sound pickup hole 15 may be arranged in the sound emitting section 123 of the main body portion 12, and it may be understood that one end of the sound emitting section 123 is connected to the transition section 124 of the main body portion 12, and the end of the sound emitting section 123 away from the transition section 124 is a free end. In the wearing state, the sound emitting section 123 and the transition section 124 are located on the front side of the ear.

In the wearing state, a second angle γ between a direction from the free end of the sound emitting section 123 toward the end connected to the transition section 124 and the positive direction of the sagittal axis is an acute angle. In this way, because the second angle γ is set as an acute angle, in the case, a surface of the sound emitting section 123 facing a triangular fossa side of the ear is a leeward surface 1231. It may be understood that there is less wind flow at the leeward surface 1231, therefore, the second sound pickup hole 15 may be arranged on the surface of the sound emitting section 123 facing the triangular fossa side of the ear, that is, the second sound pickup hole 15 is arranged facing the triangular fossa side of the ear. In this way, the problem of relatively large wind noise caused by excessive wind flow at the second sound pickup hole 15 may be avoided.

The second angle γ ranges from 20 degrees to 60 degrees.

In some embodiments, the second angle γ may range from 20 degrees to 45 degrees. In some embodiments, the second angle γ may range from 20 degrees to 35 degrees. Within this angular range, the wind flow blown to the second sound pickup hole 15 is small, which will not cause the problem of wind noise. In some embodiments, the second angle γ may be set to 20 degrees, 25 degrees, 30 degrees, 35 degrees, 40 degrees, 45 degrees, 50 degrees, 55 degrees or 60 degrees. The specific value thereof is not specifically limited in the present application.

It should be noted that, in order to control the earphone, such as controlling volume or controlling switching of music tracks and other functions, the wind noise reduction earphone structure may further include a function button 16, and different control functions may be realized through different operations on the function button 16.

The function button 16 may be arranged on the leeward surface 1231 of the sound emitting section 123, and the function button 16 protrudes from the leeward surface 1231. In order to further play a role in blocking wind, the second sound pickup hole 15 may be arranged on the leeward surface 1231 and on a side of the function button 16 away from the front side of the human body, that is, along a negative direction of the sagittal axis, the second sound pickup hole 15 may be blocked by the function button 16, so that the wind flow blown to the second sound pickup hole 15 may be further reduced, so as to further reduce wind noise.

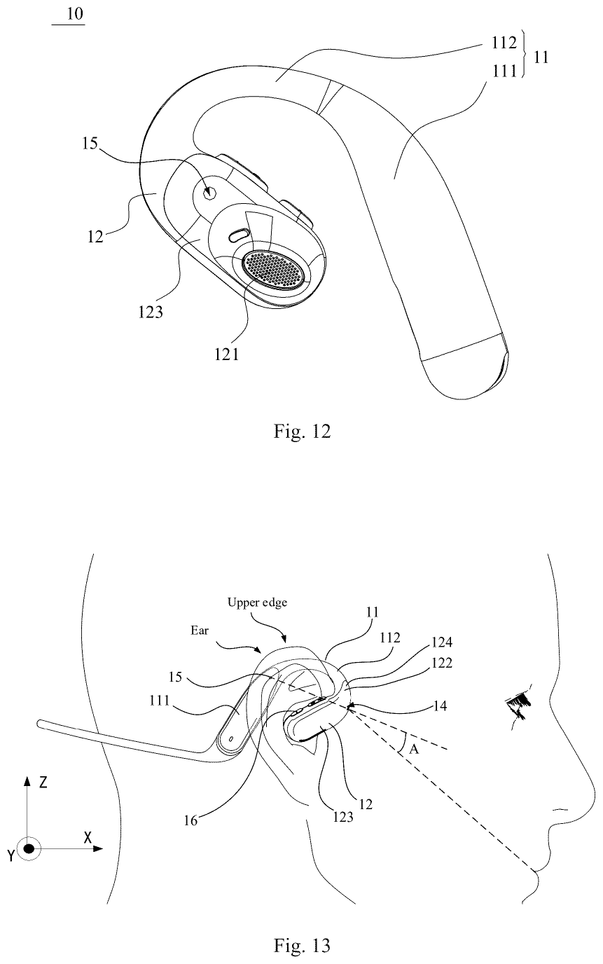

Different from the above embodiment in which the second sound pickup hole 15 is arranged on the leeward surface 1231 of the sound emitting section 123, in some embodiments, please refer to FIG. 12, which is a schematic structural view of a wind noise reduction earphone structure according to another embodiment of the present application. The second sound pickup hole 15 may be arranged on a side where the sound outlet hole 121 is located. It may be understood that at least one second microphone is installed in the sound emitting section 123, the sound emitting section 123 is provided with the sound outlet hole 121 and at least one second sound pickup hole 15 acoustically coupled with the second microphone, the sound outlet hole 121 is located on a side of the sound emitting section facing the ear hole, and the second sound pickup hole 15 is on the same side as the sound outlet hole 121, that is, the second sound pickup hole 15 also faces the side where the ear hole is located. In this way, by the shielding formed by the sound emitting section 123 and the ear, the wind can be avoided, so that the wind flow blown to the second sound pickup hole 15 can be effectively reduced, thereby reducing wind noise.

In some embodiments, please refer to FIG. 2 and FIG. 7, the second sound pickup hole 15 may also be arranged in the ear hook portion 11, and the second sound pickup hole 15 is shielded by the cooperation between the ear hook portion 11 and the ear, thereby avoiding wind. It may be understood that, in this case, at least one second microphone is installed in the ear hook portion 11, the ear hook portion 11 is provided with at least one second sound pickup hole 15, and the second sound pickup hole 15 is acoustically coupled with the second microphone.

The ear hook portion 11, as a structure worn on the ear, may include a functional section 111 and a bending section 112, one end of the bending section 112 is connected to the main body portion 12, for example, one end of the bending section 112 is connected to the transition section 124 of the main body portion 12, the other end of the bending section 112 is bent and extending toward the functional section 111 and connected to the functional section 111, and in the wearing state, the bending section 112 is bent and extending from the front side of the ear to the rear side of the ear via the upper edge of the ear.

It may be understood that the bending section 112 has elasticity, so as to facilitate wearing by the user. It may also be understood that the exterior of the bending section 112 may be covered or not covered with a flexible material (such as polycarbonate, polyamide, acrylonitrile-butadiene-styrene copolymer, silica gel, etc.) as needed, or may be partially or completely covered with the flexible material as needed, so as to improve wearing comfort as needed.

The functional section 111 of the ear hook portion 11 is provided with the second sound pickup hole 15 and the second microphone. In the wearing state, the functional section 111 is located on the rear side of the ear. In this way, under the shielding of the ear, the wind can be avoided, so that the wind flow blown to the second sound pickup hole 15 can be effectively reduced, thereby reducing wind noise.

In order to better shield the second sound pickup hole 15, please continue to refer to FIG. 2 and FIG. 7, the functional section 111 includes a first side surface 1111 facing the ear, and the second sound pickup hole 15 is arranged on the first side surface 1111. In this way, the ear can better shield the second sound pickup hole 15, so that the wind flow blown to the second sound pickup hole 15 can be effectively reduced, thereby reducing wind noise.

It may be understood that, the first sound pickup hole 14, the first microphone 13, the second sound pickup hole 15 and the second microphone are provided to cooperate with each other to perform noise reduction in combination with a noise reduction algorithm. In order to improve the cooperation effect among the first sound pickup hole, the first microphone 13, the second sound pickup hole 15 and the second microphone, the positional relationship between the first sound pickup hole 14 and the second sound pickup hole 15 may be defined.

In some embodiments, please refer to FIG. 13, which is a schematic structural view of still another wind noise reduction earphone structure worn on an ear according to an embodiment of the present application. When one first sound pickup hole 14 is provided, a third angle A formed by a connection line from the second sound pickup hole 15 to the first sound pickup hole 14 and a connection line from the first sound pickup hole 14 to a corner of a mouth on a corresponding side is less than or equal to 60 degrees. In this way, at this angle, wind noise and other environmental noise can be further suppressed in combination with the noise reduction algorithm, so as to further improve the audio performance of the earphone.

In some embodiments, please refer to FIG. 2, when at least two first sound pickup holes 14 are provided, a third angle A formed by a connection line from the second sound pickup hole 15 to the first sound pickup hole 14 closest to the mouth in the positive direction of the sagittal axis and a connection line from the first sound pickup hole 14 closest to the mouth in the positive direction of the sagittal axis to a corner of the mouth on a corresponding side is less than or equal to 60 degrees. In this way, at this angle, wind noise and other environmental noise may be further suppressed in combination with the noise reduction algorithm, so as to further improve the audio performance of the earphone.

It may be understood that, in the positive direction (X direction) of the sagittal axis, there is a first sound pickup hole 14 closest to the mouth in the at least two first sound pickup holes 14, and for the convenience of understanding, this first sound pickup hole 14 is named as a first sub-sound pickup hole. In this way, the third angle A formed by the connection line from the second sound pickup hole 15 to the first sound pickup hole 14 closest to the mouth in the positive direction of the sagittal axis and the connection line from the first sound pickup hole 14 closest to the mouth in the positive direction of the sagittal axis to the corner of the mouth on the corresponding side being less than or equal to 30 degrees may be understood as: a third angle A formed by a connection line from the second sound pickup hole 15 to the first sub-sound pickup hole and a connection line from the first sub-sound pickup hole to the corner of the mouth on the corresponding side being less than or equal to 60 degrees.

In some embodiments, the third angle A is less than or equal to 45 degrees, and in some embodiments, the third angle A is less than or equal to 30 degrees.

It should be noted that, due to the fluid attribute of wind, when the wind flows through an object with a mesh structure, the object may play a role in blocking and dispersing the wind fluid to some extent.

Based on this, in order to disperse and block the wind fluid to some extent, the wind noise reduction earphone structure 10 may further include a blocking component with a mesh structure, and the blocking component may be arranged in the first sound pickup hole 14 and/or the second sound pickup hole 15. In this way, the wind entering the first sound pickup hole 14 and/or the second sound pickup hole 15 may be blocked and dispersed to some extent by the blocking component with the mesh structure, so as to reduce the wind energy blown to the first sound pickup hole 14 and/or the second sound pickup hole 15, thereby reducing wind noise.

In order not to affect the sound pickup quality of the microphone while reducing wind energy, the acoustic resistance of the blocking component may be set between 9×107 Pa·s/m³ and 9×1012 Pa·s/m³, for example, the acoustic resistance of the blocking component may be set to 9×107 Pa·s/m³, 9×108 Pa·s/m³, 9×109 Pa·s/m³, 9×1010 Pa·s/m³ or 9×1012 Pa·s/m³.

In some embodiments, the area of a single mesh hole in the blocking component may be set between 0.04 square millimeters and 0.07 square millimeters. In some embodiments, the area of a single mesh hole in the blocking component may be set between 0.04 square millimeters and 0.0625 square millimeters, for example, the area of a single mesh hole in the blocking component may be set to 0.04 square millimeters, 0.05 square millimeters, 0.0625 square millimeters or 0.07 square millimeters.

Alternatively, the open area ratio of the blocking component may be set between 20% and 48%. For example, the open area ratio of the blocking component may be set to 20%, 30%, 40% or 48%.

In some embodiments, the blocking component may be an acoustic mesh cloth or a steel mesh with a mesh structure.

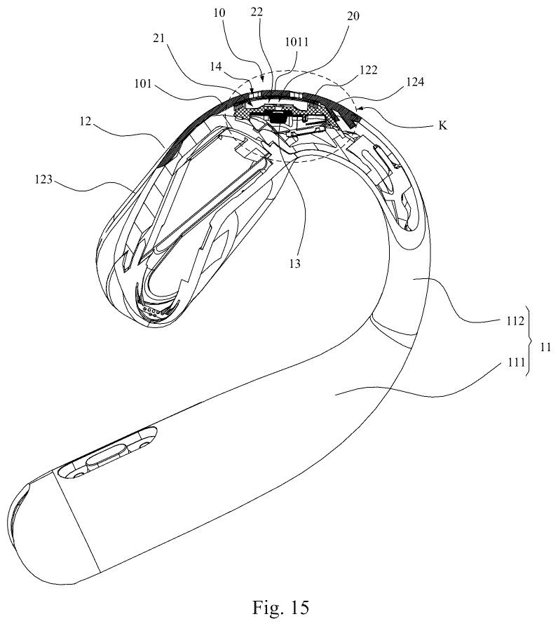

In some embodiments, please refer to FIG. 15 and FIG. 16, FIG. 15 is a partial cross-sectional view of an earphone according to an embodiment of the present application, and FIG. 16 is an enlarged view of a portion K in FIG. 15. The wind noise reduction earphone structure 10 includes a housing 101 provided with at least one sound pickup hole 14, and at least one microphone 13 is installed in the housing 101. It may be understood that more than one microphone 13 may form an array of microphones 13, so that external sound signals can be picked up more accurately.

A first acoustic channel 20 is formed in the housing 101, the first acoustic channel 20 includes a slow flow channel 21 and a conduction channel 22 that are in communication with each other, the sound pickup hole 14 is in communication with the slow flow channel 21, the slow flow channel 21 is configured to buffer gas flowing in from the sound pickup hole 14, and the conduction channel 22 is acoustically coupled with the microphone 13. In this way, by providing the first acoustic channel 20 in the housing 101 and connecting the sound pickup hole 14 in the housing 101 with the slow flow channel 21 of the first acoustic channel 20, when wind blows in from the sound pickup hole 14, the slow flow channel 21 may play a certain role in slowing down the wind, thereby slowing down the flow velocity of the wind fluid, reducing wind energy, further reducing wind noise, and effectively improving the sound pickup effect of the microphone 13, and improving user experience.

The minimum spacing of the first acoustic channel 20 in the axial direction of the sound pickup hole 14 may be set to be greater than or equal to 0.3 millimeters. In some embodiments, the minimum spacing of the first acoustic channel 20 in the axial direction of the sound pickup hole 14 may be set to be 0.8 millimeters. In some embodiments, the minimum spacing of the first acoustic channel 20 in the axial direction of the sound pickup hole 14 may be set to be 1.5 millimeters.

When the first acoustic channel 20 is longer, the minimum spacing of the first acoustic channel 20 in the axial direction of the sound pickup hole 14 should be set to be larger accordingly, so as to avoid changing the frequency response characteristic of the sound picked up by the microphone 13, while ensuring the reduction of wind noise.

In some embodiments, please refer to FIG. 16, as a structure for reducing wind noise, the slow flow channel 21 has a slow flow wall 211 that is arranged opposite to the sound pickup hole 14 and is configured to buffer the gas flowing in from the sound pickup hole 14, and the slow flow wall 211 is recessed in a direction away from the sound pickup hole 14. It may be understood that, since the slow flow channel 21 has the slow flow wall 211 that is arranged opposite to the sound pickup hole 14 and is recessed in the direction away from the sound pickup hole 14, in this way, when wind flows in from the sound pickup hole 14, the flow direction of part of the wind may be changed to some extent by the recessed slow flow wall 211, so as to form a certain resistance to the wind, slow down the flow velocity of the wind fluid, reduce the wind energy of the wind flowing to the microphone 13, further reduce wind noise, and effectively improve the sound pickup effect of the microphone 13.

As shown in FIG. 16, the conduction channel 22 has a conduction wall 221 opposite to the housing 101, and the conduction wall 221 is provided with a second sound pickup hole 2211 acoustically coupled with the microphone 13. It may be understood that sound may be transmitted to the microphone 13 through the second sound pickup hole 2211 in the conduction wall 221.

In some embodiments, in order to make full use of the structural features of the housing 101, part of the housing wall of the housing 101 may be used as part of the structure of the first acoustic channel 20, for example, the housing 101 includes a first wall 1011 provided with the sound pickup hole 14, the first acoustic channel 20 includes a channel wall, and the channel wall and the first wall 1011 are arranged opposite to each other in the axial direction of the sound pickup hole 14 to define the first acoustic channel 20.

Specifically, the channel wall may include the slow flow wall 211 and the conduction wall 221 connected to the slow flow wall 211, the slow flow wall 211 is arranged opposite to the sound pickup hole 14, and the slow flow wall 211 is recessed in a direction away from the sound pickup hole 14, and the slow flow wall 211 is configured to buffer the gas flowing in from the sound pickup hole 14. The slow flow wall 211 and a first portion of the first wall 1011 may define the slow flow channel 21, and the conduction wall 221 and a second portion of the first wall 1011 may define the conduction channel 22.

It may be understood that, as a component that effectively reduces wind noise, in order to effectively block the wind entering the sound pickup hole 14, the sound pickup hole 14 may be arranged such that an orthographic projection of the sound pickup hole 14 on a first plane at least partially overlaps with an orthographic projection of the slow flow wall 211 on the first plane, where the first plane is a plane perpendicular to the axis of the sound pickup hole 14. In this way, the wind flowing in from the sound pickup hole 14 may first be buffered and decelerated by the slow flow wall 211 before flowing to the microphone 13, so that the wind energy flowing to the microphone 13 is relatively small, thereby reducing wind noise.

Preferably, the sound pickup hole 14 may be arranged such that the orthographic projection of the sound pickup hole 14 on the first plane completely overlaps with the orthographic projection of the slow flow wall 211 on the first plane.

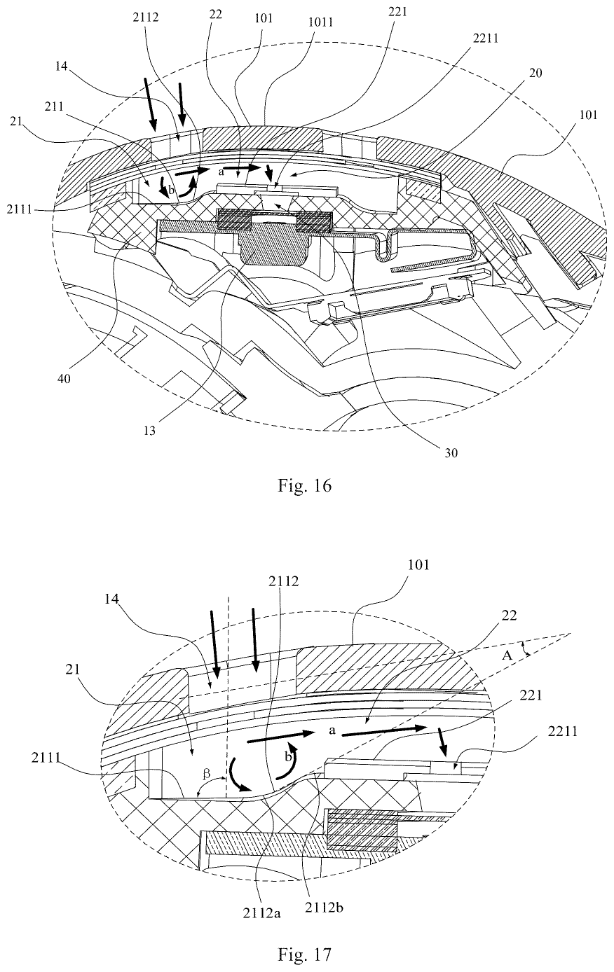

In some embodiments, in order to better receive the wind fluid from the sound pickup hole 14 and effectively buffer and decelerate the wind fluid, please refer to FIG. 16 and FIG. 17, FIG. 17 is an enlarged view of a partial structure of a first acoustic channel according to an embodiment of the present application. The slow flow wall 211 may include a bottom wall 2111, and a second angle β between the bottom wall 2111 and a first direction is less than or equal to 120 degrees in a direction from an end of the bottom wall 2111 close to the conduction channel 22 to an end of the bottom wall 2111 away from the conduction channel 22. In some embodiments, the second angle β is less than or equal to 110 degrees. Furthermore, preferably, the second angle β is less than or equal to 90 degrees, where the first direction is parallel to the axis of the sound pickup hole 14 and faces the side where the sound pickup hole 14 is located. At this angle, when the wind fluid is blown from the sound pickup hole 14 to the bottom wall 2111, the bottom wall 2111 may play a certain role in changing the direction of the wind fluid, that is, part of the wind fluid changes direction, so that the wind fluid with changed direction may form a certain resistance, slow down the flow velocity of the wind fluid flowing to the microphone 13, and make the wind energy flowing to the microphone 13 smaller, thereby reducing wind noise.

The contour edge of the bottom wall 2111 may form a closed shape composed of a plurality of arcs, or the contour edge of the bottom surface may form a closed shape composed of a circle, an ellipse or a runway shape, or the shape may be a triangle, a quadrangle or other polygonal shapes, which is not limited in the present application.

In order to reduce wind energy, the minimum distance between the bottom wall 2111 and the sound pickup hole 14 in the axial direction of the sound pickup hole 14 is greater than or equal to 1.5 millimeters. In some embodiments, the minimum distance between the bottom wall 2111 and the sound pickup hole 14 in the axial direction of the sound pickup hole 14 is greater than or equal to 2 millimeters. Furthermore, in some embodiments, the minimum distance between the bottom wall 2111 and the sound pickup hole 14 in the axial direction of the sound pickup hole 14 is greater than or equal to 3 millimeters. In this way, the wind fluid has enough buffer space, so that the slow flow effect is better.

Further, in order to better slow down the flow velocity of the wind fluid flowing in from the sound pickup hole 14, please refer to FIG. 17, the slow flow wall 211 includes the flow guiding wall 2112 and the bottom wall 2111, the flow guiding wall 2112 is connected to the bottom wall 2111 and the conduction wall 221, and the flow guiding wall 2112 extends obliquely from an end connected to the bottom wall 2111 in a direction close to the second sound pickup hole 2211 in the conduction wall 221. When the wind fluid is blown from the sound pickup hole 14 to the bottom wall 2111, the bottom wall 2111 may guide the wind fluid to the flow guiding wall 2112, and the obliquely extending flow guiding wall 2112 may play a certain role in changing the direction of the wind fluid, that is, part of the wind fluid changes direction, so that the wind fluid with changed direction may form a certain resistance, reduce the flow velocity of the wind fluid flowing to the microphone 13, and make the wind energy flowing to the microphone 13 smaller, thereby reducing wind noise. In this way, with the cooperation of the bottom wall 2111 and the flow guiding wall 2112, wind noise may be effectively reduced.

In some embodiments, the flow guiding wall 2112 has one flow guiding surface, or is formed by at least two flow guiding surfaces connected to each other in a transitional manner. At least one flow guiding surface extends obliquely from an end of the flow guiding surface close to the bottom wall 2111 in a direction close to the second sound pickup hole 2211. In this way, the obliquely extending flow guiding surface may play a certain role in changing the direction of the wind fluid, that is, part of the wind fluid changes direction, so that the wind fluid with changed direction may form a certain resistance, slow down the flow velocity of the wind fluid flowing to the microphone 13, and make the wind energy flowing to the microphone 13 smaller, thereby reducing wind noise.

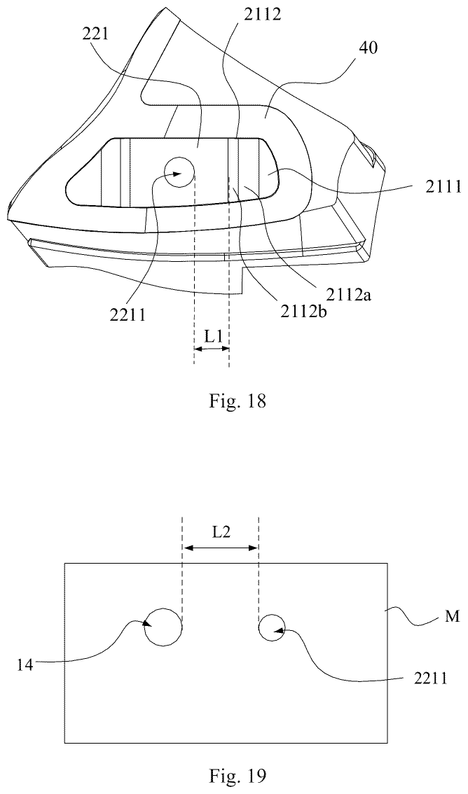

For example, as shown in FIG. 17 and FIG. 18, the flow guiding wall 2112 may include two flow guiding surfaces, which are a first flow guiding surface 2112a and a second flow guiding surface 2112b respectively. The first flow guiding surface 2112a and the second flow guiding surface 2112b are connected to each other in a transitional manner, the first flow guiding surface 2112a is connected to the bottom wall 2111, and the second flow guiding surface 2112b is connected to the conduction wall 221, the first flow guiding surface 2112a extends obliquely from an end of the first flow guiding surface 2112a close to the bottom wall 2111 in a direction close to the second sound pickup hole 2211.

At least one flow guiding surface forms a first angle A with a first plane, and the first angle A is between 30 degrees and 89 degrees. For example, the first angle A may be 30 degrees, in some embodiments it is 45 degrees, and in some further embodiments it is 89 degrees, and the first plane is perpendicular to the axial direction of the sound pickup hole 14. By adjusting the angle between the flow guiding surface and the first plane, the angle at which part of the wind fluid flows in the slow flow channel 21 may be adjusted, and the wind fluid with the adjusted angle is the wind fluid with changed direction. Since the flow direction of the wind fluid with changed direction b is opposite to the flow direction of the wind fluid a flowing along the first acoustic channel 20, resistance may be formed, thereby slowing down the flow velocity of the wind fluid, and reducing the wind energy of the wind flowing to the second sound pickup hole 2211.

For example, when the flow guiding surface includes the first flow guiding surface 2112a and the second flow guiding surface 2112b, the first flow guiding surface 2112a may be arranged to form the first angle A with the first plane, and the first angle A is between 30 degrees and 89 degrees. For example, the first angle A may be 30 degrees, in some embodiments it is 45 degrees, and in some further embodiments it is 89 degrees.

It may be understood that, after the flow velocity of the wind fluid flowing in from the sound pickup hole 14 is slowed down by the recess structure composed of the flow guiding wall 2112 and the bottom wall 2111, the wind fluid flows to the second sound pickup hole 2211 in the conduction wall 221, and then flows from the second sound pickup hole 2211 to the microphone 13. It may also be understood that, the farther the second sound pickup hole 2211 is from the recess structure, the smaller the wind energy finally flowing into the second sound pickup hole 2211 may be, so that the wind energy flowing to the microphone 13 may be smaller. Therefore, in this embodiment of the present application, as shown in FIG. 18, the minimum distance L1 from the connection edge between the flow guiding wall 2112 and the conduction wall 221 to the outer edge of the second sound pickup hole 2211 in the conduction wall 221 may be set to be greater than or equal to 1.5 millimeters. In some embodiments, the minimum distance L1 may be set to be between 3 millimeters and 5 millimeters, and in some embodiments, the minimum distance L1 may be set to be between 7 millimeters and 10 millimeters. In this way, the second sound pickup hole 2211 may be as far away from the recess structure composed of the flow guiding wall 2112 and the bottom wall 2111 as possible, so that the wind energy flowing into the second sound pickup hole 2211 may be more effectively reduced, thereby enabling the wind energy flowing to the microphone 13 to be smaller. In some embodiments, the minimum distance L1 may be set to 1.5 millimeters, 3 millimeters, 5 millimeters, 7 millimeters or 10 millimeters.

It may also be understood that, because the sound pickup hole 14 is arranged opposite to the recess structure composed of the flow guiding wall 2112 and the bottom wall 2111, the distance between the sound pickup hole 14 and the second sound pickup hole 2211 may also affect the buffering of wind energy. Based on this, in order to more effectively reduce the wind energy flowing into the second sound pickup hole 2211, please refer to FIG. 19, which is a schematic orthographic projection view of a sound pickup hole and a second sound pickup hole on a second plane according to an embodiment of the present application. The minimum distance L2 between the outer edge of the orthographic projection of the second sound pickup hole 2211 on the second plane M and the outer edge of the orthographic projection of the sound pickup hole 14 on the second plane M is greater than or equal to 2 millimeters, where the second plane is perpendicular to the axis of the second sound pickup hole 2211. In some embodiments, the minimum distance L2 may be set to be between 3 millimeters and 6 millimeters, and in some embodiments, the minimum distance L2 may be set to be between 7 millimeters and 10 millimeters. In some embodiments, the minimum distance L2 may be set to 2 millimeters, 3 millimeters, 6 millimeters, 7 millimeters or 10 millimeters.

When a plurality of sound pickup holes 14 are provided, it may be that the minimum distance L2 between the outer edge of the orthographic projection of the second sound pickup hole 2211 on the second plane M and the outer edge of the orthographic projection of any one sound pickup hole 14 on the second plane M is greater than or equal to 2 millimeters. In some embodiments, the minimum distance L2 may be set to be between 3 millimeters and 6 millimeters, and in some embodiments, the minimum distance L2 may be set to be between 7 millimeters and 10 millimeters. In some embodiments, the minimum distance L2 may be set to 2 millimeters, 3 millimeters, 6 millimeters, 7 millimeters or 10 millimeters.

It may also be understood that, the second sound pickup hole 2211 is acoustically coupled with the microphone 13 through the sound pickup channel 30 to realize sound pickup by the microphone 13, where the aperture of the sound pickup channel 30 is gradually reduced in a second direction, where the second direction is parallel to the axis of the sound pickup channel 30 and points to the side where the microphone 13 is located. In other words, the aperture of the sound pickup channel 30 is gradually reduced in a direction close to the microphone 13. In this way, as the aperture of the sound pickup channel 30 is reduced, the wind energy is also gradually weakened, so as to weaken the wind energy flowing to the microphone 13.

The extension length of the sound pickup channel 30 is not less than 2 millimeters, so that the wind energy flowing to the microphone 13 may be effectively weakened.

In some embodiments, the sound pickup channel 30 may be provided with a waterproof and breathable membrane. The waterproof and breathable membrane may be made of any one selected from a group consisting of polytetrafluoroethylene, expanded polytetrafluoroethylene, polyurethane resin, thermoplastic polyurethane elastomer, etc. The waterproof and breathable membrane can play a role in further blocking wind energy, while protecting the microphone from water.

It should be noted that, due to the fluid attribute of wind, when the wind flows through an object with a mesh structure, the object may play a role in blocking and dispersing the wind fluid to some extent.

Based on this, in order to disperse and block the wind fluid to some extent, the wind noise reduction earphone structure may further include a blocking component with a mesh structure, and the blocking component may be arranged in the sound pickup hole 14 and/or the second sound pickup hole 2211. In this way, the wind entering the sound pickup hole 14 and/or the second sound pickup hole 2211 may be blocked and dispersed to some extent by the blocking component with the mesh structure, so as to reduce the wind energy blown to the sound pickup hole 14 and/or the second sound pickup hole 2211, thereby reducing wind noise.

In order not to affect the sound pickup quality of the microphone 13 while reducing wind energy, the acoustic resistance of the blocking component may be set between 9×107 Pa·s/m³ and 9×1012 Pa·s/m³, for example, the acoustic resistance of the blocking component may be set to 9×107 Pa·s/m³, 9×108 Pa·s/m³, 9×109 Pa·s/m³, 9×1010 Pa·s/m³ or 9×1012 Pa·s/m³.

In some embodiments, the area of a single mesh hole in the blocking component may be set between 0.04 square millimeters and 0.0625 square millimeters, for example, the area of a single mesh hole in the blocking component may be set to 0.04 square millimeters, 0.05 square millimeters or 0.0625 square millimeters.

Alternatively, the open area ratio of the blocking component may be set between 20% and 48%. For example, the open area ratio of the blocking component may be set to 20%, 30%, 40% or 48%.

In some embodiments, the blocking component may be an acoustic mesh cloth or a steel mesh with a mesh structure.

Certainly, it may be understood that, the blocking component with the mesh structure may also be arranged in the sound pickup channel 30.

In some embodiments, in order to facilitate the arrangement of the sound pickup channel 30, please refer to FIG. 16 and FIG. 17, the wind noise reduction earphone structure 10 may further include a mounting member 40 on which the microphone 13 is mounted, the mounting member 40 is located on one side of the conduction wall 221, the mounting member 40 is provided with the sound pickup channel 30, and the sound pickup channel 30 acoustically couples the second sound pickup hole 2211 with the microphone 13.

The mounting member 40 may be made of a plastic material, for example, the plastic material may be PC, ABS or the like, or the mounting member may also be made of a plastic material and foam (EVA), and certainly, the mounting member may also be made of a plastic material and soft rubber (silica gel, rubber, TPU, TPE). The present application is not limited in this aspect.

On the other hand, an embodiment of the present application further provides an earphone, which includes an electroacoustic transducer and the above wind noise reduction earphone structure 10, and the electroacoustic transducer is arranged in the wind noise reduction earphone structure. It may be understood that the electroacoustic transducer is a device that can convert acoustic energy into electrical energy or convert electrical energy into acoustic energy, such as a speaker or a microphone.

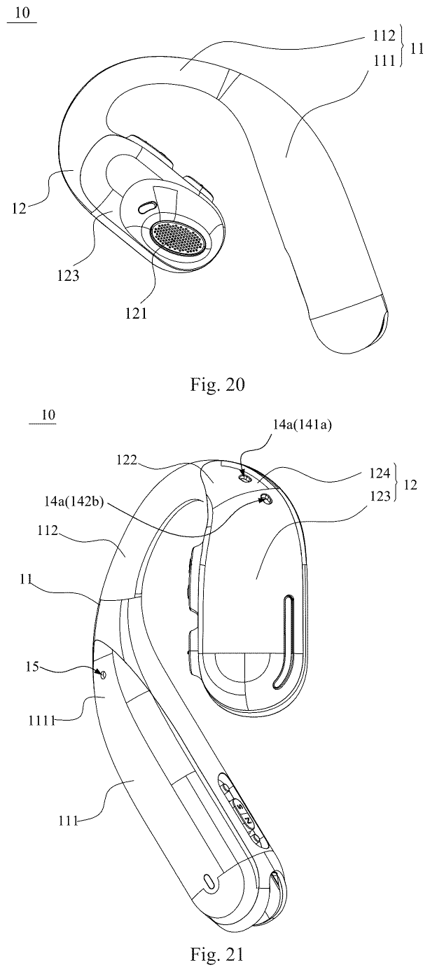

Please refer to FIG. 20 and FIG. 21, in conjunction with FIG. 14, FIG. 20 is a schematic structural view of an earphone in a first viewing angle according to an embodiment of the present application, and FIG. 21 is a schematic structural view of an earphone in a second viewing angle according to an embodiment of the present application. The earphone includes an ear hook portion 11 and a main body portion 12, the ear hook portion 11 is connected to the main body portion 12, and the ear hook portion 11 is configured to be worn on an ear, so that the main body portion 12 is located on a front side of the ear. It may be understood that the main body portion 12 is provided with a speaker (not shown) and a sound outlet hole 121, and the sound outlet hole 121 is acoustically coupled with the speaker, so that when the main body portion 12 is located on the front side of the ear, sound may be transmitted to an ear hole of the ear through the sound outlet hole 121, and the user can hear corresponding sound information.

It may also be understood that, for the convenience of wearing, one end of the ear hook portion 11 is connected to the main body portion 12, and the other end of the ear hook portion 11 is bent and extending from the front side of the ear to a rear side of the ear via an upper edge of the ear, so that the earphone structure can be worn on the ear.

For ease of understanding, the sound pickup hole 14 of the wind noise reduction earphone structure 10 described above may be a first sound pickup hole 14a, and the microphone 13 of the wind noise reduction earphone structure 10 may be a first microphone.

In order to pick up external sound signals and convert them into electrical signals for processing by the signal processor in the earphone system, at least one first microphone is installed inside the main body portion 12. It may be understood that more than one first microphone may form a first microphone array, so that external sound signals can be picked up more accurately.

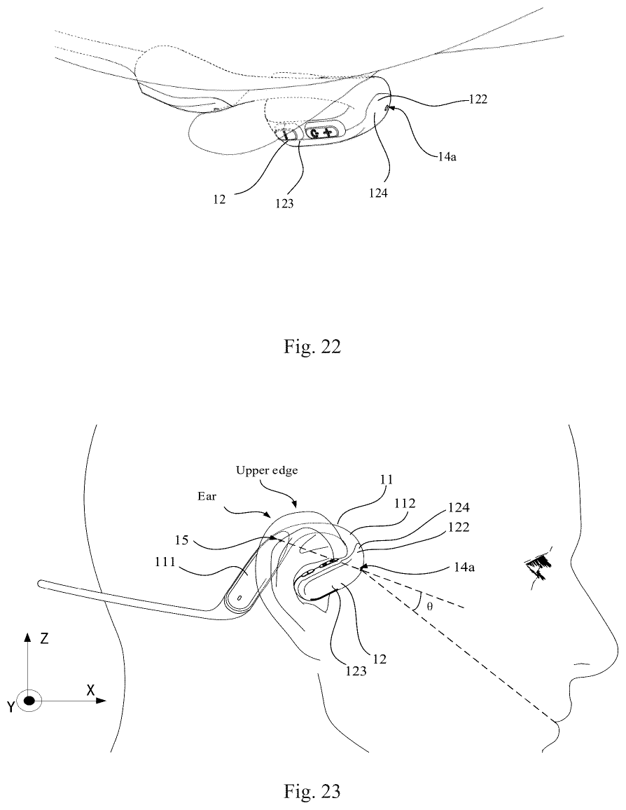

As shown in FIG. 21 and FIG. 22, FIG. 22 is a schematic partial structural view of a main body portion according to an embodiment of the present application. The main body portion 12 may include an arc-shaped wall 122 protruding from an inner side to an outer side of the main body portion 12, the arc-shaped wall 122 is provided with at least one first sound pickup hole 14a, and the first sound pickup hole 14a is configured to be acoustically coupled with the first microphone. It may be understood that the first sound pickup hole 14a may transmit external sound signals to the first microphone.

It may also be understood that, since the arc-shaped wall 122 is arranged in an arc shape, when wind acts on the arc-shaped wall 122, wind energy may quickly disperse to two sides of the arc surface, thereby reducing energy of the wind blowing into the first sound pickup hole 14a, further reducing wind noise, effectively improving a sound pickup effect of the first microphone, and improving user experience.

It should be noted that, as a structure for transmitting sound, the cross-section of the first sound pickup hole 14a may have a circular, elliptical, triangular, quadrangular or irregular shape, and the specific shape thereof is not specifically limited in the present application.

In order to meet sound pickup quality of the first microphone, the area of the cross-section of the first sound pickup hole 14a is not less than 0.75 square millimeters. It may be understood that, in general, the larger the area of the cross-section of the first sound pickup hole 14a, the better the sound pickup effect. However, when the area of the cross-section of the first sound pickup hole 14a is greater than a certain value, wind noise may be increased. Based on this, the area of the cross-section of the first sound pickup hole 14a in the present application is not greater than 3 square millimeters. That is, in order to meet the sound pickup quality of the first microphone and reduce wind noise, the area of the cross-section of the first sound pickup hole 14a is not less than 0.75 square millimeters and not greater than 3 square millimeters, for example, the area of the cross-section of the first sound pickup hole 14a is 0.75 square millimeters, 0.80 square millimeters, 1 square millimeter, 1.5 square millimeters, 2 square millimeters, 2.5 square millimeters or 3 square millimeters, so that the earphone has a better sound pickup effect.

As shown in FIG. 21 and FIG. 22, in conjunction with FIG. 14, the main body portion 12 includes a sound emitting section 123 and a transition section 124 for connecting the sound emitting section 123 and the ear hook portion 11, the transition section 124 includes the arc-shaped wall 122, one end of the arc-shaped wall 122 is connected to the sound emitting section 123, and the other end of the arc-shaped wall 122 is bent and extending toward the ear hook portion 11 and connected to the ear hook portion 11. In this way, the arc-shaped wall 122 can achieve a smooth and curved transition between the sound emitting section 123 and the ear hook portion 11, so as to disperse wind energy blowing toward the arc-shaped wall 122.

It should be noted that, generally, wind energy along the front side of the human body toward the rear side of the human body is higher than wind energy in other directions. Based on this, in order to better disperse relatively large wind energy, the arc-shaped wall 122 is arranged on a surface of the transition section 124 facing the front side of the human body. In this way, the energy of the wind blowing into the first sound pickup hole 14a may be better reduced, that is, wind noise may be better reduced, and the sound pickup effect of the first microphone may be effectively improved.

Specifically, a middle protrusion of the arc-shaped wall 122 is gradually bent and extending to transit to left and right sides thereof to form a wind guiding surface, and the first sound pickup hole 14a may be located on the wind guiding surface. It may be understood that the wind guiding surface with such a shape is favorable for dispersing wind energy.

Preferably, the first sound pickup hole 14a may be located at the middle of the arc-shaped wall 122, that is, at the middle of the wind guiding surface. In this way, when wind acts on the arc-shaped wall 122, wind energy may quickly disperse to two sides of the wind guiding surface, thereby reducing the energy of the wind blowing into the first sound pickup hole 14a, further reducing wind noise, and effectively improving the sound pickup effect of the first microphone.

In some embodiments, the arc-shaped wall 122 includes points with different radii of curvature, which may be between 2 millimeters and 40 millimeters. In some embodiments, the radii of curvature of the points may be between 2.65 millimeters and 37.5 millimeters, so that wind energy may be effectively dispersed. In some embodiments, the radius of curvature of each point may be 2 millimeters, 2.65 millimeters, 3.15 millimeters, 3.75 millimeters, 22.15 millimeters, 32.5 millimeters, 37.5 millimeters or 40 millimeters. It may be understood that the radius of curvature of each point may be any value between 2.65 millimeters and 37.5 millimeters, which is not limited in the present application.

In some embodiments, the radius of curvature of each point may be between 3.15 millimeters and 32.5 millimeters.

In some embodiments, the radius of curvature of each point may be between 3.75 millimeters and 22.15 millimeters, so that wind energy may be effectively dispersed.

It should be noted that, when using the earphone, the user most likely encounters oncoming wind, that is, the wind direction is along the front side of the human body toward the rear side of the human body.

Based on this, please refer to FIG. 14 and FIG. 21, in order to further improve the wind noise reduction effect, two first sound pickup holes 14a may be provided, which are a first sub-hole 141a and a second sub-hole 142b respectively. In the wearing state, the first sub-hole 141a is closer to the eye than the second sub-hole 142b in a positive direction of the sagittal axis (X direction). A third angle α between a connection line between the first sub-hole 141a and the second sub-hole 142b and the positive direction of the sagittal axis is less than or equal to 90 degrees. In this way, the connection line between the first sub-hole 141a and the second sub-hole 142b is designed at such an angle, which is favorable for unloading of wind energy, so as to further improve the wind noise reduction effect.

Preferably, the third angle α is less than or equal to 60 degrees. In some embodiments, the third angle α is less than or equal to 45 degrees. Further, in some embodiments, the third angle α is 0 degree.

It should be noted that, in order to better reduce wind noise, in some embodiments, a second microphone and a third sound pickup hole acoustically coupled with the second microphone may also be provided, so that noise reduction may be performed in combination with a call noise reduction and an active noise reduction algorithm.

It may be understood that, the second microphone is provided and matched with the third sound pickup hole, and a microphone array may be formed together with the first microphone and the first sound pickup hole, so that call noise reduction may be realized.

It may also be understood that, by providing the second microphone and the third sound pickup hole, external noise signals may be collected and used as reference signals for noise reduction processing, and active noise reduction may be realized in combination with an algorithm of a noise reduction chip.

In some embodiments, please refer to FIG. 14 and FIG. 21, the third sound pickup hole 15 may be arranged in the ear hook portion 11, and the third sound pickup hole 15 is shielded by the cooperation between the ear hook portion 11 and the ear, so as to avoid wind. It may be understood that, in this case, at least one second microphone is installed in the ear hook portion 11, the ear hook portion 11 is provided with at least one third sound pickup hole 15, and the third sound pickup hole 15 is acoustically coupled with the second microphone.

The ear hook portion 11, as a structure worn on the ear, may include a functional section 111 and a bending section 112, one end of the bending section 112 is connected to the main body portion 12, for example, one end of the bending section 112 is connected to the transition section 124 of the main body portion 12, the other end of the bending section 112 is bent and extending toward the functional section 111 and connected to the functional section 111, and in the wearing state, the bending section 112 is bent and extending from the front side of the ear to the rear side of the ear via the upper edge of the ear.

It may be understood that the bending section 112 has elasticity, so as to facilitate wearing by the user. It may also be understood that the exterior of the bending section 112 may be covered or not covered with a flexible material (such as polycarbonate, polyamide, acrylonitrile-butadiene-styrene copolymer, silica gel, etc.) as needed, or may be partially or completely covered with the flexible material as needed, so as to improve wearing comfort as needed.

The functional section 111 of the ear hook portion 11 is provided with the third sound pickup hole 15 and the second microphone. In the wearing state, the functional section 111 is located on the rear side of the ear. In this way, under the shielding of the ear, the role of avoiding wind may be played, so that the wind flow blown to the third sound pickup hole 15 may be effectively reduced, thereby reducing wind noise. It may be understood that, the sound pickup hole 14 of the wind noise reduction earphone structure 10 described above may be the third sound pickup hole 15, the microphone 13 of the wind noise reduction earphone structure 10 may be the second microphone, and the third sound pickup hole 15 and the second microphone may be arranged with reference to the sound pickup hole 14 and the microphone 13 described above, which will not be repeated in the present application.

In order to better shield the third sound pickup hole 15, please continue to refer to FIG. 14 and FIG. 21, the functional section 111 includes a first side surface 1111 facing the ear, and the third sound pickup hole 15 is arranged on the first side surface 1111. In this way, the ear can better shield the third sound pickup hole 15, so that the wind flow blown to the third sound pickup hole 15 may be effectively reduced, thereby reducing wind noise.

The third sound pickup hole 15 may also be provided with the blocking component of the wind noise reduction earphone structure 10 described above.

It may be understood that, the first sound pickup hole 14a, the first microphone, the third sound pickup hole 15 and the second microphone are provided to cooperate with each other to perform noise reduction in combination with a noise reduction algorithm. In order to improve the cooperation effect among the first sound pickup hole 14a, the first microphone, the third sound pickup hole 15 and the second microphone, the positional relationship between the first sound pickup hole 14a and the third sound pickup hole 15 may be defined.

In some embodiments, please refer to FIG. 23, which is a schematic structural view of an earphone worn on an ear according to another embodiment of the present application. When one first sound pickup hole 14a is provided, a fourth angle θ formed by a connection line from the third sound pickup hole 15 to the first sound pickup hole 14a and a connection line from the first sound pickup hole 14a to a corner of a mouth on a corresponding side is less than or equal to 60 degrees. In this way, at this angle, wind noise and other environmental noise may be further suppressed in combination with the noise reduction algorithm, so as to further improve the audio performance of the earphone.

In some embodiments, please refer to FIG. 14, when at least two first sound pickup holes 14a are provided, a fourth angle θ formed by a connection line from the third sound pickup hole 15 to the first sound pickup hole 14a closest to the mouth in the positive direction of the sagittal axis and a connection line from the first sound pickup hole 14a closest to the mouth in the positive direction of the sagittal axis to a corner of the mouth on a corresponding side is less than or equal to 60 degrees. In this way, at this angle, wind noise and other environmental noise may be further suppressed in combination with the noise reduction algorithm, so as to further improve the audio performance of the earphone.

It may be understood that, in the positive direction (X direction) of the sagittal axis, there is a first sound pickup hole 14a closest to the mouth in the at least two first sound pickup holes 14a, and for the convenience of understanding, this first sound pickup hole 14a is named as a first sub-sound pickup hole. In this way, the fourth angle θ formed by the connection line from the third sound pickup hole 15 to the first sound pickup hole 14a closest to the mouth in the positive direction of the sagittal axis and the connection line from the first sound pickup hole 14a closest to the mouth in the positive direction of the sagittal axis to the corner of the mouth on the corresponding side being less than or equal to 30 degrees may be understood as: a fourth angle θ formed by a connection line from the third sound pickup hole 15 to the first sub-sound pickup hole and a connection line from the first sub-sound pickup hole to the corner of the mouth on the corresponding side being less than or equal to 60 degrees.

In some embodiments, the fourth angle θ is less than or equal to 45 degrees. In some embodiments, the fourth angle θ is less than or equal to 30 degrees.

In a second aspect, an embodiment of the present application further provides an earphone, which includes an electroacoustic transducer and the wind noise reduction earphone structure 10 described above, and the electroacoustic transducer is arranged in the wind noise reduction earphone structure. It may be understood that, the electroacoustic transducer is a device that may convert sound energy into electrical energy or convert electrical energy into sound energy, such as a speaker or a microphone.

Obviously, those skilled in the art may make various modifications and variations to the present application without departing from the spirit and scope of the present application. In this way, if these modifications and variations of the present application fall within the scope of the claims of the present application and their equivalent technologies, the present application is also intended to include these modifications and variations.

1. A wind noise reduction earphone structure, comprising a housing, wherein the housing comprises an ear hook portion and a main body portion, the ear hook portion is connected to the main body portion, and the ear hook portion is configured to be worn on an ear, so that the main body portion is located on a front side of the ear,
at least one first microphone is installed inside the main body portion, the main body portion comprises an arc-shaped wall protruding from an inner side to an outer side of the main body portion, the arc-shaped wall is provided with at least one first sound pickup hole, and the first sound pickup hole is configured to be acoustically coupled with the first microphone;
the main body portion comprises a sound emitting section and a transition section for connecting the sound emitting section and the ear hook portion, the transition section comprises the arc-shaped wall, one end of the arc-shaped wall is connected to the sound emitting section, and the other end of the arc-shaped wall is bent and extending toward the ear hook portion and connected to the ear hook portion.

2. (canceled)

3. The wind noise reduction earphone structure of claim 1, wherein the arc-shaped wall is arranged on a surface of the transition section facing a front side of a human body.

4. The wind noise reduction earphone structure of claim 3, wherein a middle protrusion of the arc-shaped wall is gradually bent and extending to transit to left and right sides to form a wind guiding surface.

5. (canceled)

6. The wind noise reduction earphone structure of claim 1, wherein two first sound pickup holes are provided, which are a first sub-hole and a second sub-hole respectively; in a wearing state, the first sub-hole is closer to an eye than the second sub-hole in a positive direction of a sagittal axis; and a first angle between a connection line between the first sub-hole and the second sub-hole and the positive direction of the sagittal axis is less than or equal to 90 degrees.

7. (canceled)

8. The wind noise reduction earphone structure of claim 1, wherein the arc-shaped wall is provided with at least three first sound pickup holes, and the at least three first sound pickup holes are arranged in a line, a triangle, a quadrangle or a circle.

9. The wind noise reduction earphone structure of claim 1, wherein in a wearing state, a second angle between a direction from a free end of the sound emitting section toward an end connected to the transition section and a positive direction of a sagittal axis is an acute angle; and at least one second microphone is installed in the sound emitting section, the sound emitting section is provided with at least one second sound pickup hole configured to be acoustically coupled with the second microphone, and the second sound pickup hole is arranged toward a triangular fossa side of the ear.

10. (canceled)

11. The wind noise reduction earphone structure of claim 1, wherein at least one second microphone is installed in the sound emitting section, the sound emitting section is provided with a sound outlet hole and at least one second sound pickup hole acoustically coupled with the second microphone, the sound outlet hole is located on a side of the sound emitting section facing an ear hole, and the second sound pickup hole is on a same side as the sound outlet hole.

12. The wind noise reduction earphone structure of claim 1, wherein at least one second microphone is installed in the ear hook portion, the ear hook portion is provided with at least one second sound pickup hole, and the second sound pickup hole is acoustically coupled with the second microphone.

13. The wind noise reduction earphone structure of claim 12, wherein the ear hook portion comprises a functional section and a bending section, one end of the bending section is connected to the main body portion, the other end of the bending section is bent and extending toward the functional section and connected to the functional section, and the functional section is provided with the second sound pickup hole and the second microphone; and in a wearing state, the functional section is located on a rear side of the ear.

14. The wind noise reduction earphone structure of claim 13, wherein the functional section comprises a first side surface facing the ear, and the second sound pickup hole is arranged on the first side surface.

15. The wind noise reduction earphone structure of claim 13, wherein one first sound pickup hole is provided, and a third angle formed by a connection line from the second sound pickup hole to the first sound pickup hole and a connection line from the first sound pickup hole to a corner of a mouth on a corresponding side is less than or equal to 60 degrees.

16. The wind noise reduction earphone structure of claim 13, wherein at least two first sound pickup holes are provided, and a third angle formed by a connection line from the second sound pickup hole to a first sound pickup hole closest to a mouth in a positive direction of a sagittal axis and a connection line from the first sound pickup hole closest to the mouth in the positive direction of the sagittal axis to a corner of a mouth on a corresponding side is less than or equal to 60 degrees.

17. The wind noise reduction earphone structure of claim 9, wherein the wind noise reduction structure further comprises a blocking component having a mesh structure, and the blocking component is arranged in the first sound pickup hole and/or the second sound pickup hole.

18-19. (canceled)

20. The wind noise reduction earphone structure of claim 1, wherein a first acoustic channel is formed in the housing, the first acoustic channel comprises a slow flow channel and a conduction channel that are in communication with each other, the first sound pickup hole is in communication with the slow flow channel, the slow flow channel is configured to buffer gas flowing in from the first sound pickup hole, and the conduction channel is acoustically coupled with the first microphone.

21. The wind noise reduction earphone structure of claim 20, wherein the slow flow channel comprises a slow flow wall that is arranged opposite to the first sound pickup hole and is configured to buffer the gas flowing in from the first sound pickup hole, and the slow flow wall is recessed in a direction away from the first sound pickup hole.

22. The wind noise reduction earphone structure of claim 21, wherein an orthographic projection of the first sound pickup hole on a first plane at least partially overlaps with an orthographic projection of the slow flow wall on the first plane, the first plane is a plane perpendicular to an axis of the first sound pickup hole.

23. (canceled)

24. The wind noise reduction earphone structure of claim 21, wherein the conduction channel comprises a conduction wall opposite to the housing, the conduction wall is provided with a second sound pickup hole acoustically coupled with the microphone, the slow flow wall comprises a flow guiding wall and a bottom wall, the flow guiding wall is connected to the bottom wall and the conduction wall, and the flow guiding wall extends obliquely from an end connected to the bottom wall in a direction close to the second sound pickup hole.

25. The wind noise reduction earphone structure of claim 24, wherein the flow guiding wall comprises one flow guiding surface or is formed by at least two flow guiding surfaces connected to each other in a transitional manner, at least one flow guiding surface extends obliquely from an end of the flow guiding surface close to the bottom wall in the direction close to the second sound pickup hole.

26-30. (canceled)

31. The wind noise reduction earphone structure of claim 24, wherein the second sound pickup hole is acoustically coupled with the microphone through a sound pickup channel;
an aperture of the sound pickup channel is gradually reduced in a second direction, the second direction is parallel to an axis of the sound pickup channel and points to a side where the microphone is located.

32-34. (canceled)

35. An earphone, comprising an electroacoustic transducer, wherein the earphone further comprises a wind noise reduction earphone structure, the wind noise reduction earphone structure comprises a housing.
wherein the housing comprises an ear hook portion and a main body portion, the ear hook portion is connected to the main body portion, and the ear hook portion is configured to be worn on an ear, so that the main body portion is located on a front side of the ear,
at least one first microphone is installed inside the main body portion, the main body portion comprises an arc-shaped wall protruding from an inner side to an outer side of the main body portion, the arc-shaped wall is provided with at least one first sound pickup hole, and the first sound pickup hole is configured to be acoustically coupled with the first microphone;
the main body portion comprises a sound emitting section and a transition section for connecting the sound emitting section and the ear hook portion, the transition section comprises the arc-shaped wall, one end of the arc-shaped wall is connected to the sound emitting section, and the other end of the arc-shaped wall is bent and extending toward the ear hook portion and connected to the ear hook portion.
